(19) United States
(12) Patent Application Publication
(10) Pub. No.: US 2025/0349244 A1
(43) Pub. Date: Nov. 13, 2025

(54) Light-emitting device with light-emitting diodes on silicon and method for efficient mass production of light-emitting devices

(71) Applicant: VisionChip Technology Ltd., Hsinchu County (TW)

(72) Inventor: Cheng-Hung Lin, Hsinchu County (TW)

(73) Assignee: VisionChip Technology Ltd., Hsinchu County (TW)

(21) Appl. No.: 19/082,224

(22) Filed: Mar. 18, 2025

Related U.S. Application Data
(60) Provisional application No. 63/647,068, filed on May 13, 2024.

(51) Int. Cl. G09G 3/32

(52) U.S. Cl. CPC G09G 3/32; G09G 2310/0275; G09G 2310/08; G09G 2320/0233; G09G 2320/0242; G09G 2320/0247; G09G 2320/064; G09G 2330/021

(57) ABSTRACT

A light-emitting device has power supply pads, driving pads, data pads, and pixels, all fabricated on a silicon substrate. Each pixel has power, driving, and data terminals that connect to the corresponding pads to receive power, driving, and data signals, respectively. Each pixel further includes light-emitting diodes (LEDs) and a control circuit. The control circuit, integrated within each pixel on the silicon substrate, regulates the operation of the LEDs in that pixel based on the received driving and data signals, thereby enabling individual pixel-level control within the device.

### CROSS REFERENCE TO RELATED APPLICATIONS

This application claims the benefit of U.S. Provisional Application No. 63/647,068, filed on May 13, 2024. The content of the application is incorporated herein by reference.

### BACKGROUND OF THE INVENTION

### 1. Field of the Invention

The present invention is in the field of light-emitting devices, and more particularly concerns light-emitting devices that utilize light-emitting diodes (LEDs). Specifically, the present technology relates to light-emitting devices incorporating LEDS fabricated on a silicon substrate.

### 2. Description of the Prior Art

Active-matrix LED displays, especially AMOLED displays, have been very popular in the market, mostly for smartphones and some larger displays. A main feature of this technology has been the use of Low-Temperature Polysilicon (LTPS) Thin-Film Transistor (TFT) backplanes to control individual pixels. These backplanes, often referred to as “traditional LTPS backplanes,” are better than amorphous silicon (a-Si) TFTs. However, as LED display technology improves, especially with the need for higher resolutions and smaller pixel sizes for micro LED and high-performance mini LED displays, the limitations of traditional LTPS backplanes are becoming more and more obvious.

Specifically, LTPS TFTs have inherent issues that make them less suitable for these advanced display applications. These issues include electron mobility being relatively low, which means potentially not enough driving power for very bright or extremely small LEDs. Importantly, traditional LTPS active matrix backplanes struggle with fast current switching. The complicated PWM control circuits in LTPS backplanes lead to slower switching speeds and, therefore, performance limitations. Furthermore, LTPS backplanes exhibit lower power efficiency in certain conditions, and the high current output needed may raise concerns about long-term reliability. Also, because LTPS material is made of many small crystals, it leads to significant variations in threshold voltage (Vth) across the display panel, resulting in uneven brightness and color, and requiring complex and costly circuits to fix this in each pixel. LTPS technology also faces challenges with long-term durability, reliability under stress, and may encounter challenges in scaling up production when making very dense micro LED arrays. These built-in issues with traditional LTPS backplane technology demonstrate the need for different solutions to meet the performance and manufacturing demands of next-generation LED displays.

### SUMMARY OF THE INVENTION

An embodiment of the present invention provides a light-emitting device, comprising a first power supply pad, a second power supply pad, a plurality of driving pads, a plurality of data pads, and a plurality of pixels. The first power supply pad is configured to receive a first power voltage. The second power supply pad is configured to receive a second power voltage. The driving pads are configured to receive driving signals. The data pads are configured to receive data signals. Each pixel comprises a first power supply terminal, a second power supply terminal, a driving terminal, a data terminal, a plurality of light-emitting diodes (LEDs) and a control circuit. The first power supply terminal is formed on a silicon substrate, is coupled to the first power supply pad, and is configured to receive the first power voltage. The second power supply terminal is formed on the silicon substrate, is coupled to the second power supply pad, and is configured to receive the second power voltage. The driving terminal is formed on the silicon substrate, is coupled to a driving pad, and is configured to receive a driving signal. The data terminal is formed on the silicon substrate, is coupled to a data pad, and is configured to receive a data signal. The LEDs are formed on the silicon substrate. The control circuit is formed on the silicon substrate, is coupled to the first power supply terminal, the second power supply terminal, the driving terminal, the data terminal and the LEDs, and is configured to control the operations of the LEDs based on the received driving signal and the received data signal.

An embodiment of the present invention provides a method of manufacturing a plurality of the light-emitting devices. The method comprises performing wafer-level processing to simultaneously form the plurality of light-emitting devices on a single silicon wafer.

An embodiment of the present invention provides a method for efficient mass production of the light-emitting devices. The method comprises performing wafer-level processing to simultaneously fabricate a plurality of light-emitting devices on a single silicon wafer, thereby achieving parallel fabrication of power supply pads, driving pads, data pads, pixels, LEDs, and control circuits of the plurality of light-emitting devices.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a plan view of a silicon wafer on which a multitude of light-emitting devices are constructed according to an embodiment of the present invention.

FIG. 2 is a plan view of a light-emitting device shown in FIG. 1 according to an embodiment of the present invention.

FIG. 3 is a circuit diagram of the light-emitting device shown in FIG. 2.

FIG. 4 is a timing diagram of the signals of the light-emitting device shown in FIG. 2.

FIG. 5 is a functional block diagram of a single pixel, in accordance with an embodiment of the present invention

FIG. 6 is a functional block diagram illustrating an alternative embodiment of the pixel, showcasing components and interconnections for a current source driving architecture, in contrast to the current sink architecture depicted in FIG. 5.

FIG. 7 is a functional block diagram illustrating another embodiment of the pixel, also employing a current sink driving architecture for the LEDs, similar to FIG. 5.

FIG. 8 is a functional block diagram illustrating yet another embodiment of the pixel, also employing a current source driving architecture for the LEDS.

FIG. 9 is a block diagram of an external Timing Control (TCON) driver, which can be incorporated into the light-emitting device 5 in accordance with an embodiment of the present invention.

FIG. 10 is a block diagram depicting a configuration employing a plurality of cascaded Timing Control (TCON) drivers 80 within the light-emitting device 5, in accordance with an embodiment of the present invention.

### DETAILED DESCRIPTION

The present invention can be understood by referring to the following detailed description and the accompanying drawings. It should be noted that in order to make it easy for the reader to understand and the drawings concise, many of the drawings in the present invention only show part of the electronic device, and the specific components in the drawings are not drawn to scale. In addition, the number and size of the components in the drawings are only for illustration purposes and do not limit the scope of the present invention.

Certain terms will be used throughout the present invention, including the specification and the appended claims, to refer to specific components. It should be understood by those skilled in the art that different manufacturers of electronic devices may refer to the same component by different names. It is not intended herein to distinguish between components that have the same function but different names.

In the following specification and claims, the words “comprising”, “containing”, “having” and the like are open-ended words, and therefore should be construed as meaning “containing but not limited to . . . ”. Therefore, when the terms “comprising”, “containing” and/or “having” are used in the description of the present invention, they specify the existence of the corresponding features, regions, steps, operations and/or components, but do not exclude the existence of one or more corresponding features, regions, steps, operations and/or components.

The directional terms used herein, such as “upper”, “lower”, “front”, “rear”, “left”, “right”, etc., are only for reference to the direction of the drawings. Therefore, the directional terms used are for illustrative purposes and do not limit the present invention. In the drawings, each drawing illustrates the general features of the methods, structures and/or materials used in a particular embodiment. However, these drawings should not be construed as defining or limiting the scope or nature of the embodiments covered by these embodiments. For example, the relative sizes, thicknesses and positions of the layers, regions and/or structures may be reduced or enlarged for clarity.

When a corresponding component (such as a layer or region) is referred to as “on” another component, it may be directly on another component, or there may be other components between the two. On the other hand, when a component is referred to as “directly on” another component, there is no component between the two. In addition, when a component is referred to as “on” another component, the two have a vertical relationship, and the component may be above or below the other component, depending on the orientation of the device.

It should be understood that when a component or layer is referred to as “connected to” another component or layer, it may be directly connected to the other component or layer, or there may be an intervening component or layer between the two. When a component is referred to as “directly connected to” another component or layer, there is no intervening component or layer between the two. In addition, when a component is referred to as “coupled to another component (or a variation thereof)”, it may be directly connected to the other component, or indirectly connected to the other component through one or more intermediate components (e.g., electrical connection).

In the present invention, when one component “electrically connects” another component, an electrical signal can flow between the two components for at least one moment during normal operation; when one component is “coupled” to another component, an electrical signal can flow between the two components at a specified time. In the present invention, when one component is “disconnected” from another component, an electrical signal cannot flow between the two components at a specified time.

The terms “approximate” or “same” are generally construed to mean within a range of plus or minus 20% of a given value, or within a range of plus or minus 10%, plus or minus 5%, plus or minus 3%, plus or minus 28, plus or minus 18, or plus or minus 0.5% of a given value.

The ordinal terms used in the specification and claims, such as “first,” “second,” etc., are used to modify components and do not imply or represent that the component(s) have any previous ordinal number, nor do they represent the order of one component relative to another, or the order in which they are manufactured. These ordinal numbers are used only to distinguish between components with the same name. The same terminology may not be used in the claims and the specification. Therefore, the first component in the specification may be the second component in the claims.

It should be understood that the embodiments described herein may be modified, recombined, and mixed to complete other embodiments without departing from the spirit of the invention. The features of the embodiments may be arbitrarily mixed and matched, as long as they do not violate the spirit of the invention or conflict with each other.

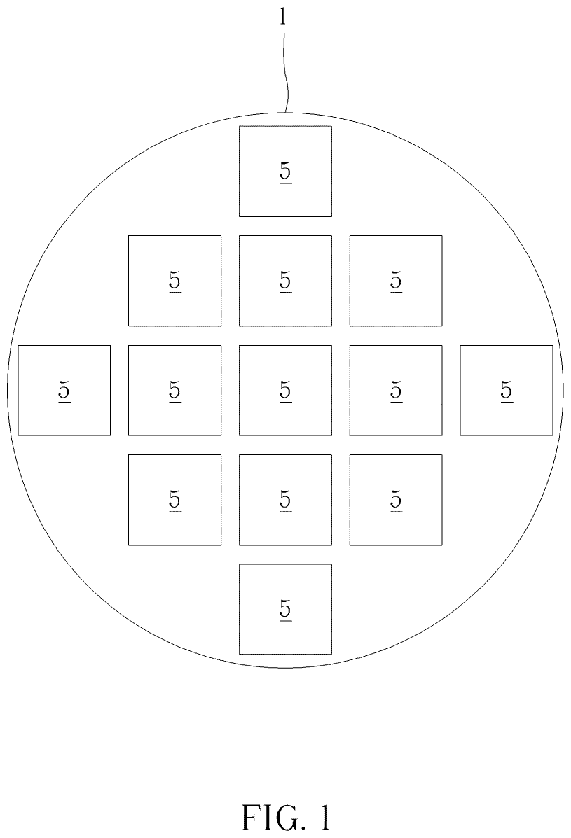

Please refer to FIG. 1. FIG. 1 is a plan view of a silicon wafer 1 upon which a plurality of light-emitting devices 5 are fabricated, in accordance with an embodiment of the present invention. As shown in FIG. 1, the silicon wafer 1 serves as a substrate on which multiple light-emitting devices 5 are formed. The arrangement of the light-emitting devices 5 across the silicon wafer 1 exemplifies a pivotal feature of the disclosed invention: the monolithic integration of multiple light-emitting devices 50 on the silicon wafer 1.

As depicted in FIG. 1, this embodiment enables efficient, large-scale production through wafer-level processing techniques. The figure demonstrates the simultaneous formation of numerous light-emitting devices 5 on the silicon wafer 1. This wafer-level fabrication approach facilitates the parallel construction of each light-emitting device's functional components, including but not limited to power supply pads, driving pads, data pads, pixel arrays comprising light-emitting diodes (LEDs), and integrated control circuitry. Such a manufacturing strategy delivers substantial benefits in production throughput and cost efficiency, laying the groundwork for high-performance, silicon-based light-emitting devices tailored for next-generation display applications.

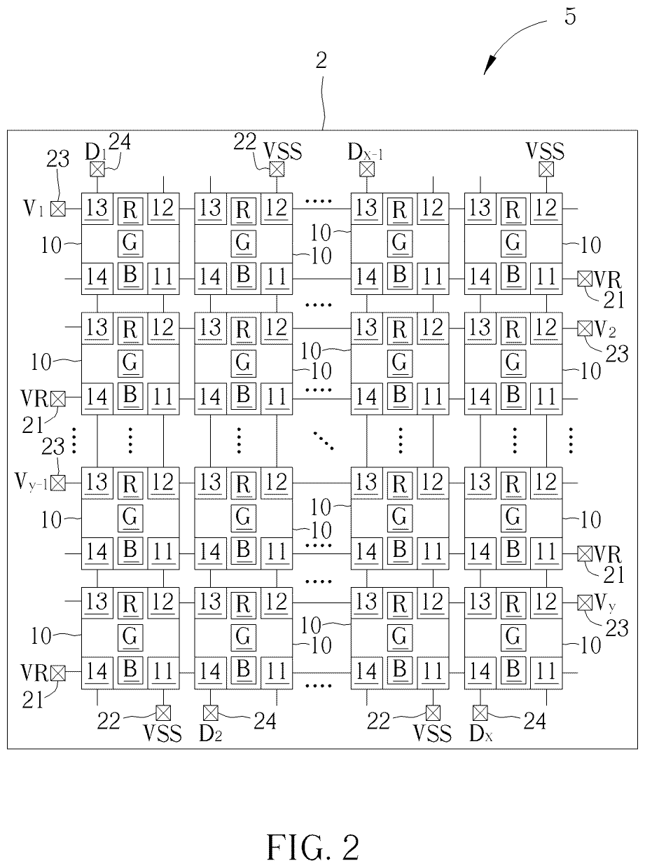

Please refer to FIG. 2. FIG. 2 is a plan view of a light-emitting device 5, which represents a singulated unit obtained from the silicon wafer 1 shown in FIG. 1, in accordance with an embodiment of the present invention. As illustrated, each light-emitting device 5 comprises a periphery defined by a portion of a silicon substrate 2, and further comprises, formed on the silicon substrate 2, at least one first power supply pad 21, at least one second power supply pad 22, a plurality of driving pads 23, a plurality of data pads 24, and an array of pixels 10. Although a plurality of first power supply pads 21 and a plurality of second power supply pads 22 are illustrated in FIG. 2, the light-emitting device 5 may have only one first power supply pad 21 and one second power supply pad 22 in another embodiment of the present invention.

Each first power supply pad 21 is configured to receive a first power voltage VR, which may be a positive direct current (DC) voltage. Each second power supply pad 22 is configured to receive a second power voltage VSS, which may be a ground voltage. The driving pads 23 are configured to receive corresponding driving signals V₁ to V_{y}, where ‘y’ represents an integer greater than one. Similarly, the data pads 24 are configured to receive corresponding data signals D₁ to Dₓ, where ‘x’ represents an integer greater than one.

Within each pixel 10, the first power supply terminal 11, the second power supply terminal 12, the driving terminal 13, and the data terminal 14 are formed on the silicon substrate 2. Each pixel 10 further comprises a plurality of light-emitting diodes (LEDs), exemplified as red (R), green (G), and blue (B) LEDs. The LEDS R, G, and B may include, for example, organic light-emitting diodes (OLEDs), sub-millimeter light-emitting diodes (mini LEDs), micro light-emitting diodes (micro LEDs), or quantum dot light-emitting diodes (quantum dot LEDs), but not limited to these. The first power supply terminal 11 of each pixel 10 is electrically coupled to the first power supply pad 21 and configured to receive the first power voltage VR. The second power supply terminal 12 of each pixel 10 is electrically coupled to the second power supply pad 22 and configured to receive the second power voltage VSS. The driving terminal 13 of each pixel 10 is electrically coupled to a corresponding driving pad 23 to receive a corresponding one of the driving signals V₁ to V_{y}. Likewise, the data terminal 14 of each pixel 10 is electrically coupled to a corresponding data pad 24 to receive a corresponding one of the data signals D₁ to Dₓ. The LEDS R, G, and B within each pixel 10 are configured to emit light responsive to the received driving and data signals.

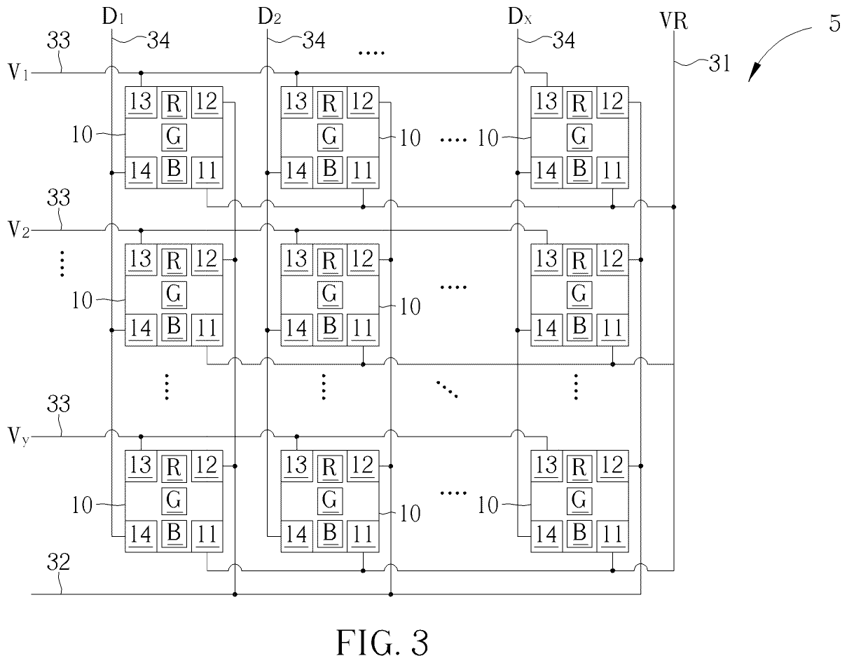

Please refer to FIG. 3. FIG. 3 is a circuit diagram of the light-emitting device 5 as depicted in FIG. 2. The light-emitting device 5 further comprises a plurality of driving lines 33 and a plurality of data lines 34, arranged in an array to facilitate addressing and control of the pixel array. Each pixel 10 is coupled to one of the plurality of driving lines 33 to receive a corresponding one of the driving signals V₁ to V_{y}, and is also coupled to one of the plurality of data lines 34 to receive a corresponding one of the data signals D₁ to Dₓ. Specifically, each row of pixels 10 is interconnected by a common driving line 33, and each column of pixels 10 is interconnected by a common data line 34. This arrangement enables active matrix addressing, where individual pixels 10 can be selectively activated by the combination of a driving signal on a driving line 33 and a data signal on a data line 34.

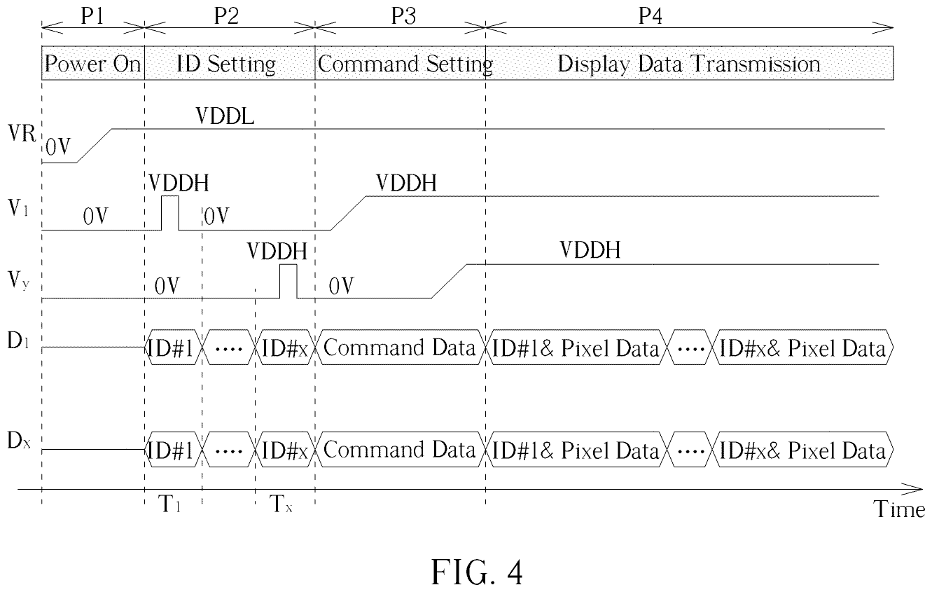

Please refer to FIG. 4. FIG. 4 is a timing diagram illustrating the signal waveforms for the light-emitting device 5 shown in FIG. 1, in accordance with an embodiment of the present invention. This timing diagram delineates the operational phases of the light-emitting device 5 into distinct periods: a “Power On” duration P1, an “ID Setting” duration P2, a “Command Setting” duration P3, and a “Display Data Transmission” duration P4. FIG. 4 is intended to clarify the waveform variations and temporal relationships of the signals applied to the light-emitting device 5 during these operational phases.

As shown in FIG. 4, the “Power On” duration P1 represents the initial stage of device activation. In this phase, the first power voltage VR rises from 0V to a low power voltage level VDDL. The driving signals V₁ to V_{y} and the data signals D₁ to Dₓ remain at a low voltage level of 0V. This phase primarily establishes the initial power supply for the light-emitting device 5, preparing it for subsequent operational stages.

The “ID Setting” duration P2 immediately follows the “Power On” duration P1. During this phase, the first power voltage VR remains at the VDDL level. The driving signals V₁ to V_{y} sequentially generate pulse signals in the time intervals T₁ to Tₓ, with their voltage levels briefly rising to a high power voltage level VDDH before returning to 0V. Concurrently, the data signals D₁ to Dₓ sequentially transmit identification code (ID) signals, such as “ID #1” to “ID #x”. The purpose of this phase is to assign a unique identification code to each pixel 10 within the light-emitting device 5, facilitating subsequent addressing and control at the pixel level.

In the “Command Setting” duration P3, the first power voltage VR remains at the low power voltage level VDDL. The driving signals V₁ to V_{y} are sequentially pulled from 0V to the high power voltage level VDDH. The data signals D₁ to Dₓ simultaneously transmit command data. The purpose of this phase is to initialize or configure the operating mode of the light-emitting device 5, for example, by setting the display mode, brightness, or other operational parameters for the entire device or pixel array.

Finally, the “Display Data Transmission” duration P4 represents the normal display operation phase of the light-emitting device 5. In this phase, the first power voltage VR remains at the low power voltage level VDDL. The driving signals V₁ to V_{y} are typically maintained at the high power voltage level VDDH to activate the corresponding rows of pixels 10. The data signals D₁ to Dₓ then sequentially transmit data packets, where each data packet, exemplified as “ID #1 & Pixel Data” to “ID #x & Pixel Data”, includes both an identification code (ID) and pixel data. The identification code (ID) within each data packet ensures that the subsequent pixel data is correctly routed to and displayed by the intended pixel 10. The pixel data portion of the data packet contains the information necessary to control the luminance of that specific pixel 10, thereby driving the light-emitting device 5 to display images.

The timing control mechanism illustrated in FIG. 4 is designed to achieve precise and efficient control of the light-emitting device 5, and specifically, individual pixels 10 within it. By controlling the timing and voltage levels of each signal in a phased manner, stable and correct operation of the light-emitting device 5 and its pixels 10 can be ensured across different operational stages, thus achieving high-quality display performance. It is noted that the low power voltage level VDDL is lower than the high power voltage level VDDH. For example, the low power voltage level VDDL may be equal to 2.8 volts, and the high power voltage level VDDH may be equal to 3.8 volts. The specific signal waveforms and timing parameters shown in FIG. 4 are exemplary and can be adjusted and optimized in practical applications based on different product requirements.

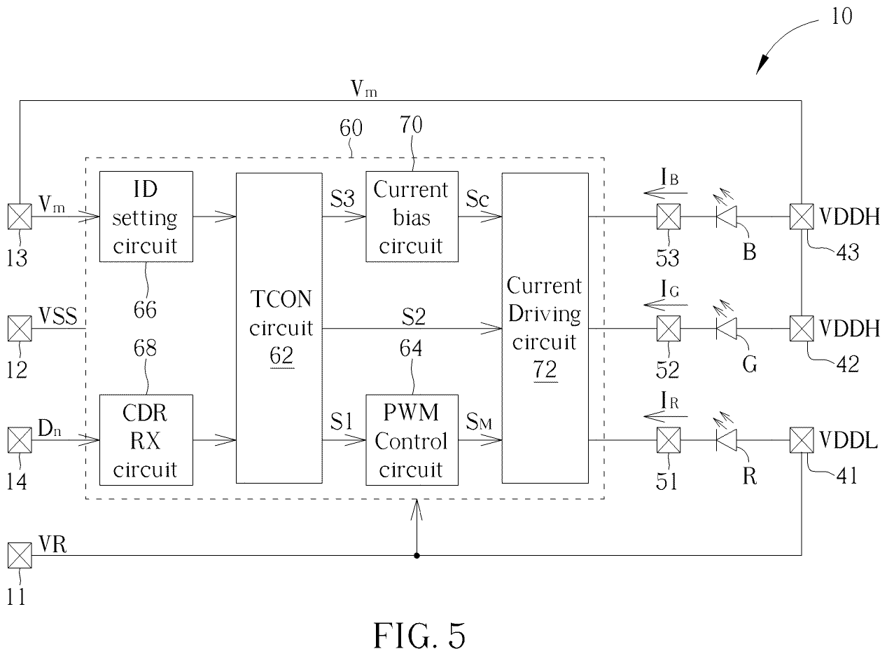

Please refer to FIG. 5. FIG. 5 is a functional block diagram of a single pixel 10, in accordance with an embodiment of the present invention. The pixel 10 further comprises a control circuit 60, which is implemented on the silicon substrate 2 and coupled to the first power supply terminal 11, the second power supply terminal 12, the driving terminal 13, the data terminal 14, and the plurality of LEDS R, G, and B. The control circuit 60 is configured to govern the light emission of the LEDS R, G, and B in response to the received driving signal Vₘ and the received data signal Dₙ. As previously noted, Vm represents one of the driving signals V₁ to V_{y}, and Dn represents one of the data signals D₁ to Dₓ, where m and n are integer indices (1≤m≤y, 1≤n≤x). In this embodiment, the control circuit 60 is configured to use a current source configuration to drive the LEDS R, G, and B. Currents I_{R}, I_{G}, and I_{B}, corresponding to LEDS R, G, and B respectively, are directed into the control circuit 60 as current sinks.

Examining the LED connections more specifically, the anode of LED R is connected to a pad 41, which is connected to the first power supply terminal 11 to receive the first power voltage VR. Since the first power voltage VR is equal to the low power voltage level VDDL after the previously mentioned “Power On” duration P1, the maximum potential of pad 41 is set to the low power voltage level VDDL. In contrast, the cathode of LED R is connected to a pad 51, which serves as the output terminal for the current I_{R} to the control circuit 60. Therefore, the control circuit 60 functions as a current sink. Similarly, anodes of LED G and LED B are connected to pads 42 and 43, respectively, both of which are connected to the driving terminal 13 to receive the driving signal Vₘ. Since the driving signal Vₘ is equal to the high power voltage level VDDH within the “Display Data Transmission” duration P4, the maximum potentials of both pad 42 and pad 43 are set to the high power voltage level VDDH, which is higher than the maximum potential VDDL of pad 41. The cathodes of LED G and LED B are connected to pads 52 and 53, respectively, which serve as current sink output terminals for the currents I_{G} and I_{B} to the control circuit 60.

The control circuit 60 comprises a timing control (TCON) circuit 62 and a pulse width modulation (PWM) control circuit 64. The TCON circuit 62 is coupled to the driving terminal 13 to receive the driving signal Vₘ and coupled to the data terminal 14 to receive the data signal Dₙ. The TCON circuit 62 is configured to generate timing signals S1, S2, and S3 based on the received driving signal Vₘ and the received data signal Dₙ. The PWM control circuit 64 is coupled to the TCON circuit 62 and configured to generate a PWM control signal S_{M} based on timing signal S1. The PWM control signal S_{M} is used to modulate the duty cycles of the currents I_{R}, I_{G}, and I_{B} through the LEDS R, G, and B, thereby regulating their emitted light intensity.

Operationally, as illustrated in the timing diagram of FIG. 4, the first power voltage VR is maintained at the low power voltage level VDDL during both the “Command Setting” duration P3 and the “Display Data Transmission” duration P4. Consequently, the anode voltage of the red LED R, connected to pad 41, is limited to a maximum potential of VDDL. In contrast, the anode voltages of the green LED G and blue LED B, connected to pads 42 and 43 respectively, can reach a higher potential of VDDH, which is greater than VDDL. This configuration of different anode voltage settings for different color sub-pixels may be employed to compensate for variations in material characteristics among different color LEDS, such as differences in forward voltage, or to adjust display characteristics such as white balance. By incorporating the PWM control circuit 64 to precisely modulate the duty cycles of currents I_{R}, I_{G}, and I_{B}, the control circuit 60 can more flexibly and accurately regulate the light emission intensity of the red, green, and blue LEDs, ultimately achieving superior full-color display performance.

The implementation of the TCON circuit 62 and the PWM control circuit 64 enables sophisticated timing control and precise brightness modulation of the LEDS R, G, and B. The adoption of a current sink architecture further helps to improve the accuracy of LED current control and the uniformity of pixel brightness.

The control circuit 60 may further comprise an ID setting circuit 66, a Clock Data Recovery (CDR) RX circuit 68, a current bias circuit 70, and a current driving circuit 72. The ID setting circuit 66 receives the driving signal Vₘ through the driving terminal 13, and may be used for decoding or storing the pixel's identification code. The CDR RX circuit 68 receives the data signal Dₙ through the data terminal 14 and may perform Clock Data Recovery (CDR) functions to extract clock and data signals. The current bias circuit 70 may be used to provide bias currents or voltage references required by the current driving circuit 72. The current driving circuit 72 generates the currents I_{R}, I_{G}, and I_{B} required to drive the LEDS R, G, and B to emit light, based on control signals S2, S_{M}, and Sc from the TCON circuit 62, the PWM control circuit 64 and the current bias circuit 70. The specific circuit configuration disclosed in FIG. 5 is exemplary and can be adjusted and optimized in practical applications according to different performance requirements.

All components of the control circuit 60 may be fabricated on silicon substrate 2 using CMOS processes, significantly boosting performance over traditional LED drivers like LTPS TFTs. Unlike LTPS, which struggles with limited electron mobility, threshold voltage (Vth) variations, and poor scalability, CMOS technology offers higher electron mobility, providing ample drive currents for the LEDs R, G, and B-ideal for high-brightness and microLED displays. The silicon substrate minimizes Vth inconsistencies, enhancing brightness and color uniformity and reducing the need for complex compensation circuits. Moreover, CMOS ensures greater stability and scalability, supporting dense LED arrays. These improvements yield faster response times, better power efficiency, and precise control of LED intensity, resulting in sharper images and superior color accuracy.

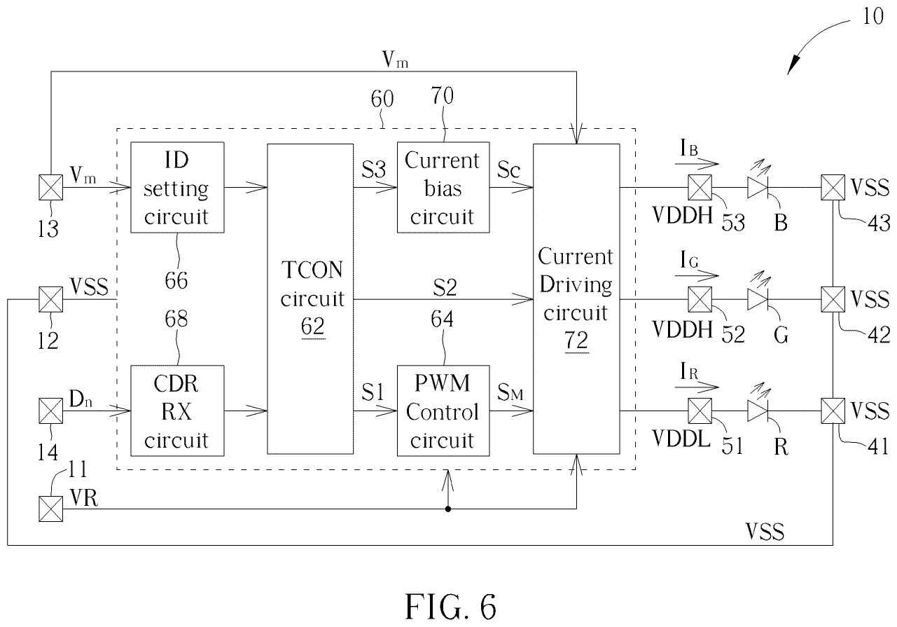

Please refer to FIG. 6. FIG. 6 is a functional block diagram illustrating an alternative embodiment of the pixel 10, showcasing components and interconnections for a current source driving architecture, in contrast to the current sink architecture depicted in FIG. 5. As shown, the pixel 10 still comprises a control circuit 60, which is implemented on the silicon substrate 2 and electrically coupled to the first power supply terminal 11, the second power supply terminal 12, the driving terminal 13, the data terminal 14, and the plurality of LEDS R, G, and B.

However, unlike the embodiment of FIG. 5, which employs a current sink configuration, the control circuit 60 in FIG. 6 is configured to utilize a current source configuration to govern the light emission of the LEDS R, G, and B. In this current source configuration, the currents I_{R}, I_{G}, and I_{B}, corresponding to LEDS R, G, and B, respectively, are sourced from the control circuit 60 to drive the LEDs. Examining the LED connections in this current source embodiment, the cathode of LED R is connected to pad 41, the cathode of LED G is connected to pad 42, and the cathode of LED B is connected to pad 43. As shown in FIG. 6, pads 41, 42, and 43 are all connected to the second power supply terminal 12 to receive the second power voltage VSS. Conversely, the anode of LED R is connected to pad 51, serving as the output terminal for the current I_{R} sourced from the control circuit 60. Similarly, the anode of LED G is connected to pad 52, and the anode of LED B is connected to pad 53, serving as current source output terminals for currents I_{G} and I_{B} sourced from the control circuit 60, respectively.

It is also noteworthy that, in contrast to FIG. 5, where pads 42 and 43 are at VDDH and pad 41 is at VDDL, in this current source configuration of FIG. 6, the anodes of LEDs G, and B (pads 52, 53) are supplied with the high power voltage VDDH, and the anode of LED R (pad 51) is supplied with the lower power voltage VDDL. This voltage level and connection scheme are consistent with a current source driving methodology, where the driving circuit actively sources current to the LEDs from a higher voltage potential.

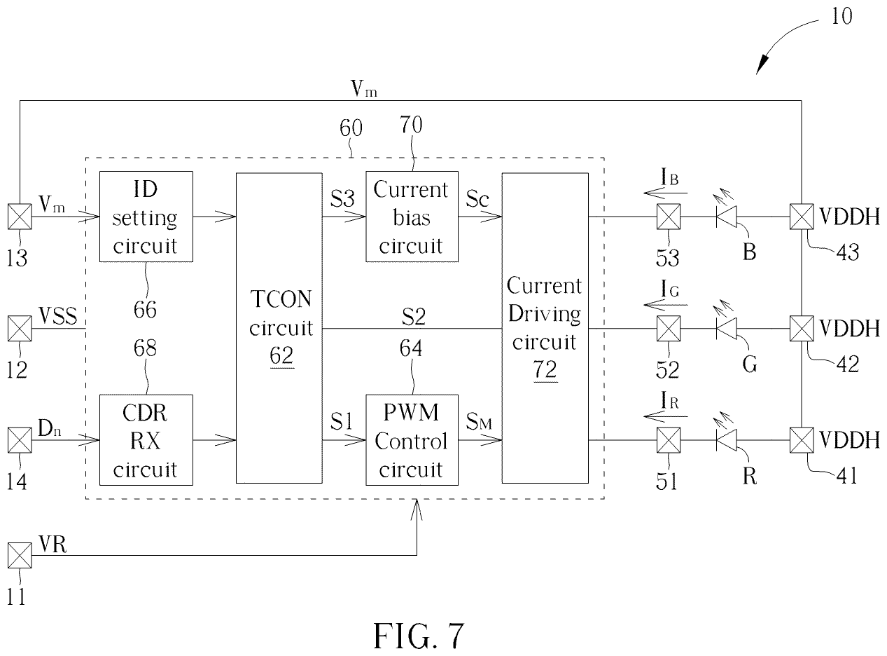

Please refer to FIG. 7. FIG. 7 is a functional block diagram illustrating another embodiment of the pixel 10, also employing a current sink driving architecture for the LEDs, similar to FIG. 5. However, in contrast to FIG. 5, in FIG. 7, the anodes of all LEDS R, G, and B are connected to the high power voltage VDDH, while a low power voltage VDDL is utilized to supply power to the control circuit 60 itself. This modification in voltage supply configuration is implemented to reduce the power consumption of the control circuit 60.

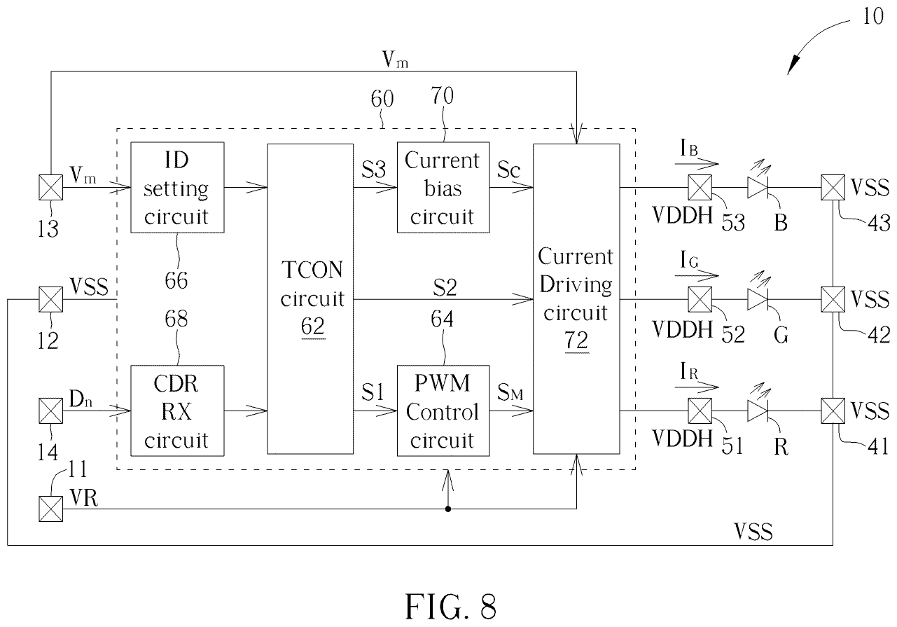

Please refer to FIG. 8. FIG. 8 is a functional block diagram illustrating yet another embodiment of the pixel 10, also employing a current source driving architecture for the LEDS R, G, and B. In this embodiment of FIG. 8, the control circuit 60 utilizes a current source method to drive the LEDs. As with the current source architecture, the control circuit 60 in FIG. 8 governs the light emission of the LEDS R, G, and B by sourcing currents I_{R}, I_{G}, and I_{B}. These currents, corresponding to LEDS R, G, and B respectively, are sourced from the control circuit 60 to drive the LEDs. Notably, in accordance with the current source configuration of FIG. 6, in FIG. 8, the anodes of all LEDS R, G, and B (pads 51, 52, 53) are supplied with the high power voltage VDDH. This uniform high voltage supply to all LED anodes in this current source embodiment may simplify the power distribution network and potentially optimize for certain performance characteristics.

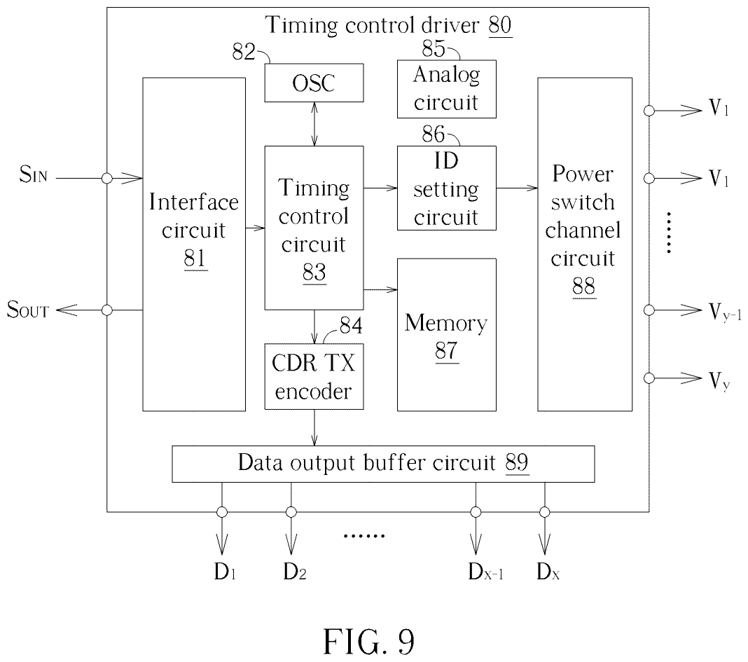

Please refer to FIG. 9. FIG. 9 illustrates a block diagram of an external Timing Control (TCON) driver 80, which can be incorporated into the light-emitting device 5 in accordance with an embodiment of the present invention. The TCON driver 80 is configured to generate the driving signals V₁ to V_{y} and the data signals D₁ to Dₓ necessary for controlling the pixel array of the light-emitting device 5, as previously described in relation to FIG. 2 and FIG. 3.

The TCON driver 80 integrates several functional circuits to achieve precise timing control and data processing. These circuits include, but are not limited to: an interface circuit 81, an oscillator (OSC) 82, a timing control circuit 83, a Clock Data Recovery (CDR) Transmitter (TX) Encoder 84, an analog circuit 85, an ID setting circuit 86, a memory 87, a power switch channel circuit 88, and a data output buffer circuit 89. The interface circuit 81 is configured to receive input signals, denoted as “SIN,” and to output signals, denoted as “SOUT,” facilitating communication and data exchange with external systems or controllers. In one embodiment, the interface circuit 81 may be specifically configured to receive and output TTL (Transistor-Transistor Logic) or LVDS (Low-Voltage Differential Signaling) data signals. The oscillator (OSC) 82 is responsible for generating a stable clock signal, which serves as the timing reference for the internal operations of the TCON driver 80. The timing control circuit 83 is the core logic block responsible for generating various timing signals and control signals required for the proper operation of the TCON driver 80. This circuit, in conjunction with the clock signal from the OSC 82, orchestrates the timing sequences for pixel addressing, data loading, and light emission control. The CDR TX encoder 84, standing for Clock Data Recovery and Transmitter Encoder, is utilized for encoding and transmitting data signals, potentially incorporating clock data recovery mechanisms to ensure reliable data transmission. The analog circuit 85 is integrated to handle analog signal processing within the TCON driver 80, which may include functions such as voltage level generation, current biasing, or analog-to-digital/digital-to-analog conversion as needed. The ID setting circuit 86 is implemented for setting or managing identification codes, potentially for pixel addressing or device identification purposes, as described in relation to FIGS. 2 to 5. The memory 87 is used to store pixel data. The power switch channel circuit 88 functions as a power management and distribution unit, controlling the power supply to different channels or sections within the light-emitting device 5, particularly for outputting the driving signals V₁ to V_{y}. The data output buffer circuit 89 serves to buffer and drive the processed data signals, ensuring robust delivery of data signals D₁ to Dₓ. In operation, the external TCON driver 80, as shown in FIG. 9, provides a comprehensive solution for generating and managing the necessary driving and data signals to control the light emission of the light-emitting device 5. By integrating these functional circuits, the TCON driver 80 enables precise timing control, data processing, and signal driving, thereby facilitating high-performance display operation of the light-emitting device 5.

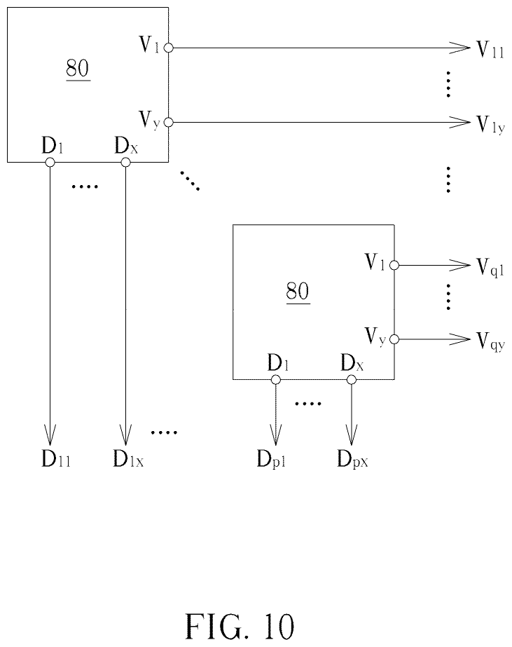

Please refer to FIG. 10. FIG. 10 is a block diagram depicting a configuration employing a plurality of cascaded timing control (TCON) drivers 80 within the light-emitting device 5, in accordance with an embodiment of the present invention. The light-emitting device 5 may incorporate the cascaded TCON drivers 80. This cascading architecture allows for scalability and modularity in controlling larger or higher-resolution pixel arrays. Moreover, the multi-TCONs cascaded topology enables the sharing of driving channels and data channels among the TCON drivers, enhancing resource efficiency and coordination. In this configuration, a first TCON driver 80 is depicted on the left side of FIG. 10. This initial TCON driver 80, similar to the one detailed in FIG. 9, is coupled to the plurality of driving pads 23 and data pads 24 of the light-emitting device 5 (as described in previous figures), and is configured to generate a first set of driving signals (V₁ to V_{y}) and data signals (D₁ to Dₓ). These output signals (V₁ to V_{y}, D₁ to Dₓ) are then utilized to control a portion of the pixel array. To extend the control capability for larger displays, the TCON drivers 80 are cascaded. FIG. 10 exemplifies this cascading concept by showing a second TCON driver 80 on the right side. The second TCON driver 80 generates a second set of driving signals (V_{q1} to V_{qy}) and data signals (Dₚ₁ to Dₚₓ), which can be used to control another section of the pixel array. p and q are integers greater than 1, and p may be equal to q. This cascading approach can be extended further by adding more TCON drivers 80 in series, allowing for the control of increasingly larger and more complex display panels. By employing cascaded TCON drivers 80, the light-emitting device 5 can effectively manage the control and driving of a large number of pixels 10. This modular and scalable architecture is particularly advantageous for high-resolution displays where a single TCON driver might not be sufficient to provide the necessary control signals for the entire pixel array. The cascaded configuration allows for distribution of the control and driving workload across multiple TCON drivers, enabling efficient and reliable operation of large-scale light-emitting devices.

The present invention offers a creative light-emitting device technology that greatly changes display making by using wafer-level processing. This method allows for making many light-emitting devices at the same time on a single silicon wafer. This way is a big change from older ways and gives major benefits in making and testing many products. A main benefit is the very large increase in making things faster. By making devices together across a whole wafer, the production rate is greatly increased, production times are shorter, and the cost for each device is much lower, making large-volume production affordable. Also, wafer-level processing naturally grows to larger wafer sizes, which is needed to meet the growing need for large, high-resolution displays. Besides making things faster, this method allows for a revolutionary way to test. With pixel connections made beforehand on the wafer, a full test of light and electricity can be done on a large group of pixels all at once. This wafer-level testing ability, possibly using camera photos for a quick check, greatly lowers testing costs for both pixel drivers and LEDs. Older, slow pixel-by-pixel testing is replaced by an easier, faster process, greatly lowering total making costs and improving the possibility of mass production for advanced display technologies. The integration as one piece on a silicon base, which comes directly from wafer-level processing, also helps with possible performance improvements and makes manufacturing simpler compared to designs that use separate LTPS backplanes. This further strengthens the benefits of this new way of making displays.

Besides fast making and testing, the light-emitting device technology of the present invention has very good display performance because of its advanced pixel control methods. First, it uses active matrix addressing, a clever technique where each pixel LED is controlled separately by its own power supply and can be turned on and off very quickly. This active control stops the screen flickering that is common with older displays that turn on pixels row by row. The result is a display with no flickering and a more comfortable view, especially important for large displays and fast-motion video. Second, the technology uses constant current Pulse Width Modulation (PWM) driving to get exact brightness and color control. LEDs are known for their narrow color range, and their color can change if the current changes. To avoid wrong colors, PWM driving changes the brightness by changing the on-off time of a constant power pulse given to each LED. This method allows for exact brightness changes without changing the LED's color range, making sure of the same and correct color showing at all brightness levels. This constant current PWM driving is needed for high-quality, color-accurate LED displays, giving a better visual experience.

Finally, saving energy is a main advantage of the light-emitting device design in the present invention. Using the natural features of LEDs, which work at low voltages and high currents, the device uses less power. Red LEDs usually work at about 2V, while green and blue LEDs are a little higher at about 3V. At the same time, LEDs are made to work well at low current levels in milliamperes. By using LEDs at these best low voltage and high current settings, the total display power use is much lower. This low-voltage, high-current way of working is a basic benefit of LED-based displays, helping to make batteries last longer in portable devices and lowering energy use in all uses. The control circuits and timing control driver are specially designed to give these efficient driving conditions to each pixel's LEDs. This focus on saving energy, together with the making and performance benefits, makes this silicon-based light-emitting device technology a very good and beneficial option for the next group of displays, meeting the needs for both high-quality pictures and uses that need less power.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light-emitting device, comprising:
a first power supply pad, configured to receive a first power voltage;
a second power supply pad, configured to receive a second power voltage;
a plurality of driving pads, configured to receive driving signals;
a plurality of data pads, configured to receive data signals; and
a plurality of pixels, each pixel comprising:
a first power supply terminal formed on a silicon substrate and coupled to the first power supply pad, configured to receive the first power voltage;
a second power supply terminal formed on the silicon substrate and coupled to the second power supply pad, configured to receive the second power voltage;
a driving terminal formed on the silicon substrate and coupled to a driving pad, configured to receive a driving signal;
a data terminal formed on the silicon substrate and coupled to a data pad, configured to receive a data signal;
a plurality of light-emitting diodes (LEDs) formed on the silicon substrate; and
a control circuit formed on the silicon substrate, coupled to the first power supply terminal, the second power supply terminal, the driving terminal, the data terminal and the plurality of LEDs, and configured to control operations of the plurality of LEDs based on the received driving signal and the received data signal.

2. The light-emitting device of claim 1, wherein the control circuit comprises:
a timing control (TCON) circuit formed on the silicon substrate and coupled to the driving terminal and the data terminal, configured to provide a timing signal based on the received driving signal and the received data signal; and
a pulse width modulation (PWM) control circuit formed on the silicon substrate and coupled to the timing control circuit, configured to provide PWM control signals based on the timing signal;
wherein the PWM control signals are used to modulate duty cycles of currents passing through the LEDs.

3. The light-emitting device of claim 2, wherein the control circuit further comprises an identification setting unit configured to setting the identification of the each pixel based on the received driving signal.

4. The light-emitting device of claim 2, wherein the control circuit further comprises a current driving circuit configured to modulate the duty cycles of the currents passing through the LEDS based on the PWM control signals.

5. The light-emitting device of claim 1, wherein the control circuit is configured to drive the plurality of LEDs using a current sink configuration.

6. The light-emitting device of claim 1, wherein the control circuit is configured to drive the plurality of LEDs using a current source configuration.

7. The light-emitting device of claim 1, further comprising an external timing control (TCON) driver coupled to the plurality of driving pads and the plurality of data pads, and configured to generate the driving signals and the data signals.

8. The light-emitting device of claim 1, further comprising a plurality of cascaded timing control (TCON) drivers coupled to the plurality of driving pads and the plurality of data pads, and configured to generate the driving signals and the data signals.

9. A method of manufacturing a plurality of light-emitting devices as claimed in claim 1, the method comprising performing wafer-level processing to simultaneously form the plurality of light-emitting devices on a single silicon wafer.

10. A method for efficient mass production of light-emitting devices as claimed in claim 1, the method comprising:
performing wafer-level processing to simultaneously fabricate a plurality of light-emitting devices on a single silicon wafer, thereby achieving parallel fabrication of power supply pads, driving pads, data pads, pixels, LEDs, and control circuits of the plurality of light-emitting devices.
